(19) United States
(12) Patent Application Publication
(10) Pub. No.: US 2025/0181377 A1
(43) Pub. Date: Jun. 5, 2025

(54) REQUEST PROCESSING METHOD AND APPARATUS, ELECTRONIC DEVICE, AND STORAGE MEDIUM

(71) Applicant: Beijing Volcano Engine Technology Co., Ltd., Beijing (CN)

(72) Inventor: Zhiyong YE, Beijing (CN)

(21) Appl. No.: 18/920,257

(22) Filed: Oct. 18, 2024

(30) Foreign Application Priority Data
Dec. 1, 2023 (CN) 202311641143.6

(51) Int. Cl. G06F 9/455

(52) U.S. Cl. CPC G06F 9/45558; G06F 2009/45579

(57) ABSTRACT

Embodiments of the present disclosure provide a request processing method and apparatus, an electronic device, and a storage medium. After receiving an input/output request sent by a virtual machine client located in user space, a kernel virtual machine module in kernel space is called to determine a target processing program corresponding to the input/output request. The target processing program includes a hook function for implementing an instruction processing flow corresponding to the input/output request, and the hook function is mapped to a kernel native code executable by a kernel. An operation is performed on a virtual input/output device at a virtual machine host by executing the target processing program in the kernel space, to obtain a request result.

### CROSS-REFERENCE TO RELATED APPLICATIONS

This application claims priority to Chinese Patent Application No. 202311641143.6, filed on Dec. 1, 2023, which is hereby incorporated by reference in its entirety.

### TECHNICAL FIELD

Embodiments of the present disclosure relate to the field of cloud computing technologies, and in particular, to a request processing method and apparatus, an electronic device, and a storage medium.

### BACKGROUND

At present, with rapid development of cloud computing technologies and business scenarios, as a virtualization technology implemented at a bottom layer of cloud computing, more attention is paid thereto. An input/output virtualization (IOV) technology is a technology for implementing data exchange between a virtual machine and an input/output device, and data exchange performance between the virtual machine and the input/output device directly affects performance of the virtual machine.

In existing virtualization technologies, for an input/output request sent by a guest side, there are problems of a low response speed and low execution efficiency of the input/output request.

### SUMMARY

Embodiments of the present disclosure provide a request processing method and apparatus, an electronic device, and a storage medium, to overcome the problems of a low response speed and low execution efficiency of an input/output request.

In a first aspect, an embodiment of the present disclosure provides a request processing method, including:
after receiving an input/output request sent by a virtual machine client located in user space, calling a kernel virtual machine module in kernel space to determine a target processing program corresponding to the input/output request, where the target processing program includes a hook function for implementing an instruction processing flow corresponding to the input/output request, and the hook function is mapped to a kernel native code executable by a kernel; and performing an operation on a virtual input/output device at a virtual machine host by executing the target processing program in the kernel space, to obtain a request result.

In a second aspect, an embodiment of the present disclosure provides a request processing apparatus, including:
a processing unit, configured to: after receiving an input/output request sent by a virtual machine client located in user space, call a kernel virtual machine module in kernel space to determine a target processing program corresponding to the input/output request, where the target processing program includes a hook function for implementing an instruction processing flow corresponding to the input/output request, and the hook function is mapped to a kernel native code executable by a kernel; and
a control unit, configured to perform an operation on a virtual input/output device at a virtual machine host by executing the target processing program in the kernel space, to obtain a request result.

In a third aspect, an embodiment of the present disclosure provides an electronic device, including: a processor and a memory;
where the memory stores a computer-executable instruction; and
the processor executes the computer-executable instruction stored in the memory, such that the processor executes the request processing method according to the first aspect and the various possible designs of the first aspect.

In a fourth aspect, an embodiment of the present disclosure provides a computer-readable storage medium, where the computer-readable storage medium stores a computer-executable instruction, and when a processor executes the computer-executable instruction, the request processing method according to the first aspect and the various possible designs of the first aspect is implemented.

In a fifth aspect, an embodiment of the present disclosure provides a computer program product, including a computer program, where the computer program, when executed by a processor, implements the request processing method according to the first aspect and the various possible designs of the first aspect.

The request processing method and apparatus, the electronic device, and the storage medium are provided in the embodiments. After receiving an input/output request sent by a virtual machine client located in user space, a kernel virtual machine module in kernel space is called to determine a target processing program corresponding to the input/output request. The target processing program includes a hook function for implementing an instruction processing flow corresponding to the input/output request, and the hook function is mapped to a kernel native code executable by a kernel. An operation is performed on a virtual input/output device at a virtual machine host by executing the target processing program in the kernel space, to obtain a request result. The kernel virtual machine module in the kernel space is called, and the target processing program corresponding to the input/output request is obtained and executed, and the kernel native code mapped by the hook function is executed in the kernel space by using the hook function in the target processing program, to implement a response to the input/output request. In this process, context switching of a processor thread and data copying between kernel space and user space can be avoided, thereby improving a response speed and execution efficiency of the input/output request.

### BRIEF DESCRIPTION OF DRAWINGS

In order to more clearly describe technical solutions in embodiments of the present disclosure or in the prior art, the following briefly describes accompanying drawings used the description of the embodiments or the prior art. It is clear that the accompanying drawings in the following description are some embodiments of the present disclosure, and a person of ordinary skill in the art may still derive other accompanying drawings from these accompanying drawings without creative efforts.

FIG. 1 is a diagram of a system architecture of a request processing method according to an embodiment of the present disclosure.

FIG. 2 is a first schematic flowchart of a request processing method according to an embodiment of the present disclosure.

FIG. 3 is a flowchart of a specific implementation of step S102 in the embodiment shown in FIG. 2.

FIG. 4 is a schematic diagram of a processing process of an input/output request according to an embodiment of the present disclosure.

FIG. 5 is a flowchart of a specific implementation of step S1022 in the embodiment shown in FIG. 3.

FIG. 6 is a second schematic flowchart of a request processing method according to an embodiment of the present disclosure.

FIG. 7 is a flowchart of a specific implementation of step S202 in the embodiment shown in FIG. 6.

FIG. 8 is a schematic structural diagram of an extended Berkeley Packet Filter module according to an embodiment of the present disclosure.

FIG. 9 is a block diagram of a structure of a request processing apparatus according to an embodiment of the present disclosure.

FIG. 10 is a schematic structural diagram of an electronic device according to an embodiment of the present disclosure.

FIG. 11 is a schematic diagram of a hardware structure of an electronic device according to an embodiment of the present disclosure.

### DETAILED DESCRIPTION OF EMBODIMENTS

To make objectives, technical solutions, and advantages of embodiments of the present disclosure clearer, the following clearly and completely describes the technical solutions in the embodiments of the present disclosure with reference to the accompanying drawings in the embodiments of the present disclosure. It is clear that the described embodiments are some but not all of the embodiments of the present disclosure. All other embodiments obtained by a person of ordinary skill in the art based on the embodiments of the present disclosure without creative efforts shall fall within the protection scope of the present disclosure.

It should be noted that the user information (including but not limited to user device information and user personal information) and data (including but not limited to data used for analysis, stored data, and displayed data) involved in the present disclosure are information and data that are authorized by a user or fully authorized by all parties. In addition, collection, use, and processing of the related data need to comply with related laws, regulations, and standards of relevant countries and regions, and corresponding operation entries are provided for the user to choose for authorization and refusing.

An application scenario of an embodiment of the present disclosure is described below.

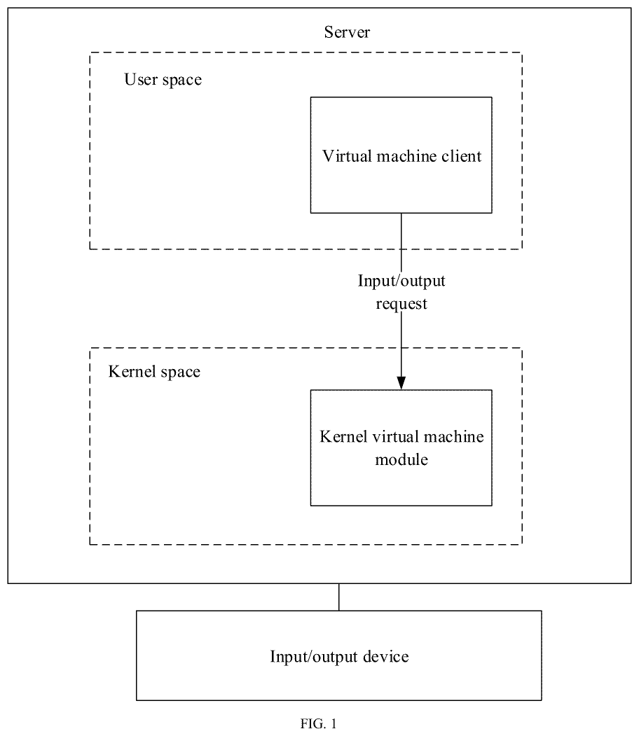

FIG. 1 is a diagram of a system architecture of a request processing method according to an embodiment of the present disclosure. The request processing method provided in this embodiment of the present disclosure may be applied to an application scenario such as cloud computing or cloud service. An execution subject of this embodiment may be a server running a virtual machine, or a central processing unit (CPU) in the server. Alternatively, the execution subject may be other electronic device that performs a similar function. More specifically, the request processing method may be applied to a scenario in which an operation is performed on an input/output (I/O or IO) device by using a kernel-based virtual machine (KVM) technology. The KVM technology is a kernel-based virtualization technology. A kernel virtual machine module (kernel virtual machine, KVM module) is embedded in an operating system (Linux), so that the operating system implements a function of hypervisor software. In addition, the virtual machine is managed based on a scheduler of the operating system. Independent running spaces are divided to perform functions with different permission levels. The spaces include kernel space and user space. The kernel space is a running space of an operating system kernel. The KVM module runs in the kernel space, and a virtualization function is implemented by driving the kernel. The user space is a running space of a user program, and is used to implement a function of a virtual machine client (Guest). As shown in FIG. 1, an input/output device is externally connected to a server. The kernel virtual machine module in the kernel space responds to and processes an input/output request sent by the virtual machine client in the user space, to finally implement an operation on the input/output device.

In the prior art, based on the KVM technology architecture shown in the foregoing figure, when a virtual machine client sends an input/output request instruction that is mapped to a physical input/output device, for example, writes data into a disk device, a CPU process of the server needs to repeatedly perform privilege level switching and data copying between the user space and the kernel space, resulting in a low response speed and low execution efficiency of the input/output request, and affecting performance of a virtual input/output device.

An embodiment of the present disclosure provides a request processing method to solve the foregoing problems.

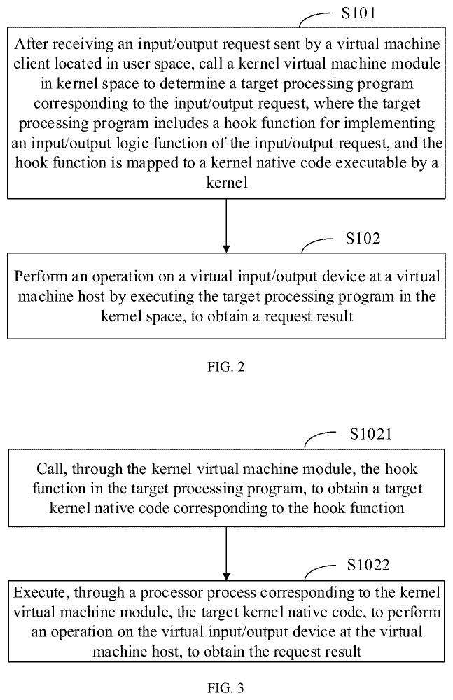

With reference to FIG. 2, FIG. 2 is a first schematic flowchart of a request processing method according to an embodiment of the present disclosure. The method in this embodiment may be applied to a server. The request processing method includes the following steps.

Step S101: after receiving an input/output request sent by a virtual machine client located in user space, call a kernel virtual machine module in kernel space to determine a target processing program corresponding to the input/output request, where the target processing program includes a hook function for implementing an input/output logic function of the input/output request, and the hook function is mapped to a kernel native code executable by a kernel.

Step S102: perform an operation on a virtual input/output device at a virtual machine host by executing the target processing program in the kernel space, to obtain a request result.

For example, with reference to a schematic diagram of a system architecture shown in FIG. 1, a virtual machine client (guest) is a virtual machine provided to a user for using and runs an independent operating system and a software program. When, in response to a user instruction or a program execution logic, the virtual machine client needs to operate an input/output device, the virtual machine client sends a request instruction, that is, an input/output request, to a virtual machine host. The input/output request enters the kernel space through a virtual queue (virtqueue) for processing. After receiving the input/output request, the kernel virtual machine module running in the kernel space parses the input/output request based on a preset protocol, to determine a program for implementing a request purpose corresponding to the input/output request, that is, the target processing program. In a possible implementation, when a virtual machine client (virtual machine) wants to write IO data, that is, operation data, the virtual machine client writes an address of a memory region corresponding to the operation data into a virtual input/output queue (virtio). In a subsequent processing step, the operation data is extracted from the virtual input/output queue by executing the target processing program, and is written into a corresponding physical input/output device, or data in the physical input/output device is read.

Further, the target processing program includes a hook (Hook) function for implementing the instruction processing flow corresponding to the input/output request, and the hook function is mapped to the kernel native code executable by the kernel. Specifically, the hook function is a function that intercepts a message or an instruction in a process in which the system transmits and processes the message or the instruction, and triggers other processing flow mapped to the hook function. In this step of this embodiment, the hook function is used to implement the instruction processing flow corresponding to the input/output request, that is, an original instruction processing flow in the target processing program is blocked by setting the hook function in the target processing program, and the instruction processing flow mapped to the hook function is executed, to control a response process and a response manner of the input/output request. Further, the kernel native code mapped to the hook function is also referred to as a native code or a machine code. The kernel native code is a program code that is pre-converted and built in the kernel space, and can be directly executed by a server (a CPU thread) in the kernel space, that is, the kernel native code executable by the kernel.

In a solution in the prior art, the kernel virtual machine module directly executes an original processing program corresponding to the input/output request. During the execution, a CPU process needs to switch back to a user-mode application process in user space (application state) to execute a corresponding processing step, and the operation data needs to be copied between the user space and the kernel space, resulting in additional consumption of computing resources and additional time consumption. In the embodiment of the present disclosure, the target processing program including the hook function is determined, and the kernel native code mapped to the hook function is used to complete a response to the input/output request. The entire execution process is completed in a kernel state (in the kernel space), and there is no need for the CPU to perform additional context switching and data copying between a user layer and a kernel layer, thereby improving instruction execution efficiency and reducing time consumption.

Further, in a possible implementation, as shown in FIG. 3, a specific implementation of step S102 includes the following steps.

Step S1021: call, through the kernel virtual machine module, the hook function in the target processing program, to obtain a target kernel native code corresponding to the hook function.

Step S1022: execute, through a processor process corresponding to the kernel virtual machine module, the target kernel native code, to perform an operation on the virtual input/output device at the virtual machine host, to obtain the request result.

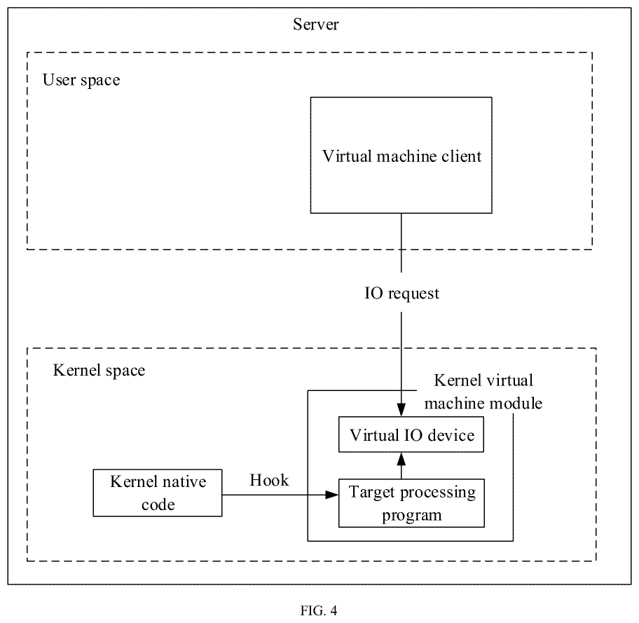

For example, FIG. 4 is a schematic diagram of a processing process of an input/output request according to an embodiment of the present disclosure. As shown in FIG. 4, a virtual input/output device (shown as a virtual IO device in the figure) that is mapped to a physical input/output device (shown as a physical IO device in the figure) is set in the kernel virtual machine module, and the input/output request (IO request) is used to perform an operation on the virtual input/output device. After receiving the input/output request sent by the virtual machine client, the kernel virtual machine module determines the target processing program corresponding to the input/output request. The target processing program is mapped to pre-generated kernel native code by using a hook function (shown as Hook in the figure). The kernel native code is generated by using an extended Berkeley Packet Filter module (extended Berkeley Packet Filter, ebpf module). A specific implementation process of generating the kernel native code by using the extended Berkeley Packet Filter is described in detail in a subsequent embodiment, and is not described here.

Then, the server executes the target processing program by using the kernel virtual machine module, and when the target processing program is executed to a target hook function in the target processing program, the target processing program is mapped to the target kernel native code corresponding to the target execution hook. Then, the target kernel native code is executed by using the processor process corresponding to the kernel virtual machine module. In this case, the processor process is in a kernel state (in the kernel space), and context switching is not required when data in the kernel space is processed, so that efficient instruction execution can be implemented.

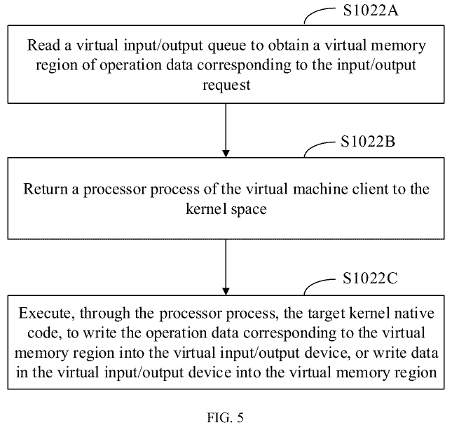

Further, in a possible implementation, as shown in FIG. 5, a specific implementation of step S1022 includes the following steps.

Step S1022A: read a virtual input/output queue to obtain a virtual memory region of operation data corresponding to the input/output request.

Step S1022B: return a processor process of the virtual machine client to the kernel space.

Step S1022C: execute, through the processor process, the target kernel native code, to write the operation data corresponding to the virtual memory region into the virtual input/output device, or write data in the virtual input/output device into the virtual memory region.

For example, the virtual input/output queue is a data queue set in the user space. The input/output request sent by the virtual machine client is stored in the virtual input/output queue. Then, a processor thread reads the input/output request from the virtual input/output queue, and obtains the virtual memory region of the operation data corresponding to the input/output request. Since the virtual input/output queue is in the user space, the processor thread is in a user state. Then, the processor thread of the virtual machine client (host) is returned (exit) to the kernel space, that is, is switched to be in the kernel state, and the target kernel native code obtained based on the target hook function is executed by using the processor process in the kernel space, to implement an operation on the virtual input/output device, that is, write the operation data corresponding to the virtual memory region into the virtual input/output device, or write the data in the virtual input/output device into the virtual memory region. Then, the virtual input/output device and the physical input/output device may perform interaction by using a direct through connection. Finally, the purpose of writing the operation data into the physical input/output device or reading the operation data from the physical input/output device is achieved. A specific implementation step is not described herein again.

In this embodiment, after receiving an input/output request sent by a virtual machine client located in user space, a kernel virtual machine module in kernel space is called to determine a target processing program corresponding to the input/output request. The target processing program includes a hook function for implementing an instruction processing flow corresponding to the input/output request, and the hook function is mapped to a kernel native code executable by a kernel. An operation is performed on a virtual input/output device at a virtual machine host by executing the target processing program in the kernel space, to obtain a request result. The kernel virtual machine module in the kernel space is called, and the target processing program corresponding to the input/output request is obtained and executed, and the kernel native code mapped by the hook function is executed in the kernel space by using the hook function in the target processing program, to implement a response to the input/output request. In this process, context switching of a processor thread and data copying between kernel space and user space can be avoided, thereby improving a response speed and execution efficiency of the input/output request.

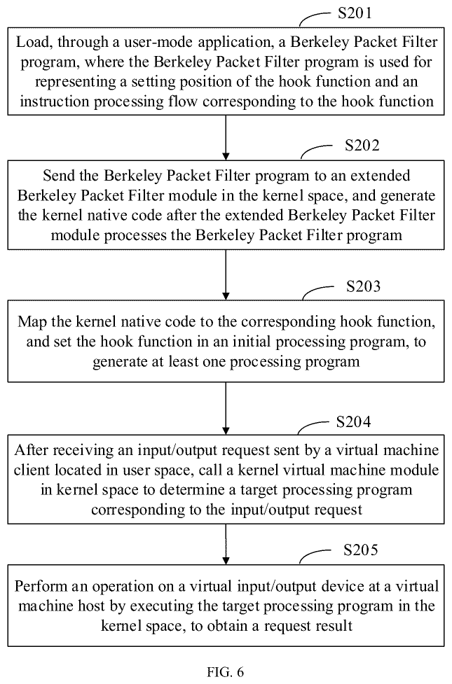

With reference to FIG. 6, FIG. 6 is a second schematic flowchart of a request processing method according to an embodiment of the present disclosure. This embodiment further adds, on the basis of the embodiment shown in FIG. 2, a step of configuring the target processing program before the input/output request is responded to. The request processing method includes the following.

Step S201: load, through a user-mode application, a Berkeley Packet Filter program, where the Berkeley Packet Filter program is used for representing a setting position of the hook function and an instruction processing flow corresponding to the hook function.

For example, first, the user-mode application is an application running in user space. Since the kernel virtual machine module runs in the kernel space, when the kernel virtual machine module does not have the capability of emulating a device, a user-mode application running in the user space is required to be used to emulate and assemble various virtual input/output devices. For example, the user-mode application includes Qemu. Further, a Berkeley Packet Filter (bpf) is a kernel engine in a Linux kernel that is used for filtering data packets. The Berkeley Packet Filter provides a specified language for an ordinary process in a user layer to filter specified data packets. A program edited based on the Berkeley Packet Filter, that is, a Berkeley Packet Filter program (bpf program), can implement a user-defined instruction processing flow through the Berkeley Packet Filter program.

Further, the Berkeley Packet Filter program may be a program file written in the user-mode application or externally imported into the user-mode application. The Berkeley Packet Filter program records an implementation code for implementing the instruction processing flow corresponding to the hook function and an implementation code indicating the setting position of the hook function in the target processing program. By using the foregoing code in the Berkeley Packet Filter program, the hook function can be inserted into the target processing program to replace the specified function and execute the user-defined instruction processing flow. Further, corresponding operation interfaces are provided for different user-mode applications to load the Berkeley Packet Filter program. A specific implementation may be flexibly set, and is not described herein again.

Step S202: send the Berkeley Packet Filter program to an extended Berkeley Packet Filter module in the kernel space, and generate the kernel native code after the extended Berkeley Packet Filter module processes the Berkeley Packet Filter program.

For example, then, the Berkeley Packet Filter program is sent from the user space to the extended Berkeley Packet Filter (ebpf) module in the kernel space. The extended Berkeley Packet Filter module further processes the Berkeley Packet Filter program, to generate the kernel native code.

In a possible implementation, a compilation module for encoding the Berkeley Packet Filter program is set in the user space, or the user-mode application has a compilation function. The Berkeley Packet Filter program is converted into a bytecode by using the compilation module or the compilation function provided by the user-mode application, and then the bytecode is sent to the extended Berkeley Packet Filter module in the kernel space. In another implementation, the Berkeley Packet Filter program may be directly sent to the extended Berkeley Packet Filter module, and the extended Berkeley Packet Filter module converts the Berkeley Packet Filter program into the bytecode and performs subsequent processing.

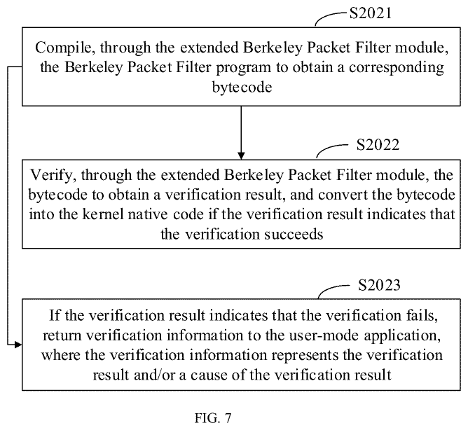

For example, as shown in FIG. 7, a specific implementation of step S202 includes the following steps.

Step S2021: compile, through the extended Berkeley Packet Filter module, the Berkeley Packet Filter program to obtain a corresponding bytecode.

Step S2022: verify, through the extended Berkeley Packet Filter module, the bytecode to obtain a verification result, and convert the bytecode into the kernel native code if the verification result indicates that the verification succeeds.

For example, based on the foregoing steps, after receiving and compiling the Berkeley Packet Filter program, the extended Berkeley Packet Filter module obtains the bytecode, and then the extended Berkeley Packet Filter module performs security verification on the bytecode by using a built-in verification module, to obtain the verification result. Then, based on the verification result, if the bytecode passes the verification, the bytecode is further converted into the kernel native code, so that a processor thread is called to execute a corresponding instruction processing flow in the kernel space in subsequent steps. Since the bytecode is a program that is generated in the user space, sent by the user-mode application, and executed in a kernel, security of the bytecode cannot be guaranteed. If a security problem exists in the bytecode, it may cause a crash of a kernel system. To ensure security, after obtaining the bytecode, the extended Berkeley Packet Filter module first verifies the bytecode, and after confirming security of the bytecode, performs code conversion to generate the kernel native code that can run in the kernel space, to ensure security and stability of the kernel system.

Further, the extended Berkeley Packet Filter module includes a verifier sub-module and a just-in-time compilation sub-module. Correspondingly, a specific implementation of step S2021 includes: verifying, through the verifier sub-module, operation security of the bytecode to obtain the verification result. A specific implementation of step S2022 includes: verify, by using the extended Berkeley Packet Filter module, the bytecode to obtain a verification result, and if the verification result indicates that the verification succeeds, convert, through the just-in-time compilation sub-module, the bytecode into the kernel native code in the kernel space.

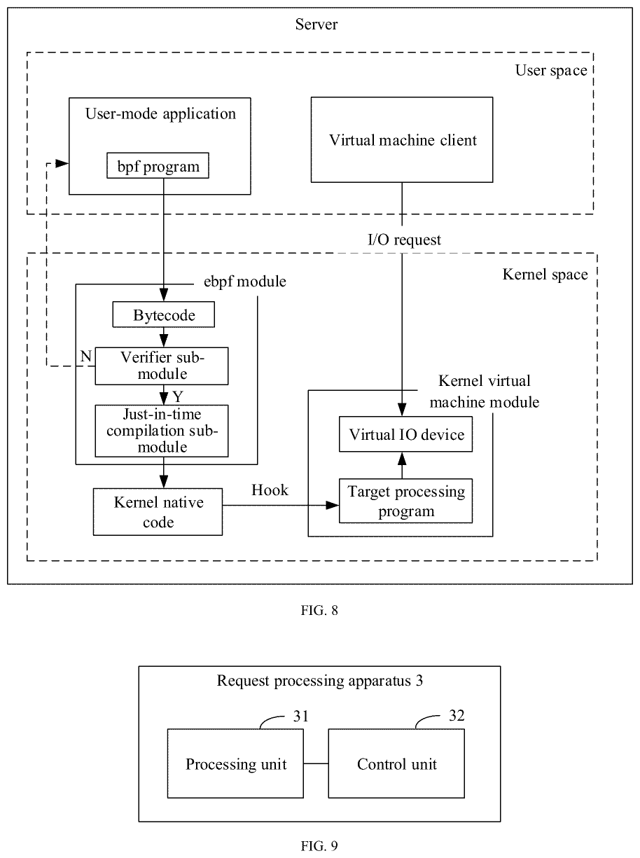

FIG. 8 is a schematic structural diagram of an extended Berkeley Packet Filter module according to an embodiment of the present disclosure. As shown in FIG. 8, after a user-mode application in user space sends a Berkeley Packet Filter program (shown as a bpf program in the figure) to an extended Berkeley Packet Filter module (shown as an ebpf module in the figure), first, in a possible implementation, the extended Berkeley Packet Filter module processes the Berkeley Packet Filter program to generate a bytecode. Then, the bytecode is sent to a verifier sub-module for processing. The verifier sub-module verifies the bytecode based on a preset security rule, to obtain a verification result. When the verification result indicates that the verification succeeds (shown as Y in the figure), the bytecode is further sent to a just-in-time compilation sub-module. The just-in-time compilation sub-module is configured to compile an eBPF bytecode into native machine instructions, that is, the kernel native code, to be more efficiently executed in the kernel.

Further, the foregoing embodiment steps further include the following step.

Step S2023: if the verification result indicates that the verification fails, return verification information to the user-mode application, where the verification information represents the verification result and/or a cause of the verification result.

For example, with reference to FIG. 8, after the bytecode is sent to the verifier sub-module for processing, and the verifier sub-module verifies the bytecode based on the preset security rule, if a verification result indicates that the verification fails (shown as N in the figure), that is, a processing logic corresponding to the bytecode program or the bytecode program itself is abnormal, which may cause a system crash or execution errors. In this case, error/exception information thrown by the verifier sub-module is obtained, and based on the error/exception information, descriptive verification information is generated, for example, the verification information includes a text expressed based on a natural language, and the verification information represents the verification result and/or the cause of the verification result. Then, the verification information is returned to the user-mode application, and is displayed in the user-mode application, or a corresponding log file is generated for recording, so that security feedback on the Berkeley Packet Filter program generated in the user space is implemented.

Step S203: map the kernel native code to the corresponding hook function, and set the hook function in an initial processing program, to generate target processing program.

Further, after the kernel native code is generated, the extended Berkeley Packet Filter module replaces the hook function, and an instruction processing flow recorded in the Berkeley Packet Filter program is executed in the hook function, to replace the instruction processing flow corresponding to the input/output request of the virtual machine, so that the processing flow of the input/output request can be executed in a manner set by a user (through the Berkeley Packet Filter program).

Specifically, the extended Berkeley Packet Filter module sets the hook function in the initial processing program, to generate at least one processing program. The at least one processing program includes the target processing program determined and used in the subsequent steps. Therefore, in a subsequent process of executing the target processing program, when the processor process executes the hook function, since the hook function has been replaced/mapped, the processor process can directly run the corresponding kernel native code without performing context switching, thereby improving data processing efficiency of the processor thread.

Step S204: after receiving an input/output request sent by a virtual machine client located in user space, call a kernel virtual machine module in kernel space to determine a target processing program corresponding to the input/output request.

Step S205: perform an operation on a virtual input/output device at a virtual machine host by executing the target processing program in the kernel space, to obtain a request result.

In this embodiment, implementations of step S204 to step S205 are the same as those of step S101 to step S102 in the embodiment shown in FIG. 2 of the present disclosure, and are not described herein again.

Corresponding to the request processing method in the foregoing embodiment, FIG. 9 is a block diagram of a structure of a request processing apparatus according to an embodiment of the present disclosure. For ease of description, only parts related to the embodiments of the present disclosure are shown. Referring to FIG. 9, a request processing apparatus 3 includes:
a processing unit 31, configured to: after receiving an input/output request sent by a virtual machine client located in user space, call a kernel virtual machine module in kernel space to determine a target processing program corresponding to the input/output request, where the target processing program includes a hook function for implementing an instruction processing flow corresponding to the input/output request, and the hook function is mapped to a kernel native code executable by a kernel; and
a control unit 32, configured to perform an operation on a virtual input/output device at a virtual machine host by executing the target processing program in the kernel space, to obtain a request result.

In an embodiment of the present disclosure, when performing the operation on the virtual input/output device at the virtual machine host by executing the target processing program in the kernel space, to obtain the request result, the control unit 32 is specifically configured to: call, through the kernel virtual machine module, the hook function in the target processing program, to obtain a target kernel native code corresponding to the hook function; and execute, through a processor process corresponding to the kernel virtual machine module, the target kernel native code, to perform an operation on the virtual input/output device at the virtual machine host, to obtain the request result.

In an embodiment of the present disclosure, when executing, through the processor process corresponding to the kernel virtual machine module, the target kernel native code, to perform the operation on the virtual input/output device at the virtual machine host, to obtain the request result, the control unit 32 is specifically configured to: read a virtual input/output queue to obtain a virtual memory region of operation data corresponding to the input/output request; return a processor process of the virtual machine client to the kernel space; and execute, through the processor process, the target kernel native code, to write the operation data corresponding to the virtual memory region into the virtual input/output device, or write data in the virtual input/output device into the virtual memory region.

In an embodiment of the present disclosure, before the receiving the input/output request sent by the virtual machine client located in the user space, the processing unit 31 is further configured to: load, through a user-mode application, a Berkeley Packet Filter program, where the Berkeley Packet Filter program is used for representing a setting position of the hook function and an instruction processing flow corresponding to the hook function; send the Berkeley Packet Filter program to an extended Berkeley Packet Filter module in the kernel space, and generate the kernel native code after the extended Berkeley Packet Filter module processes the Berkeley Packet Filter program; and map the kernel native code to the corresponding hook function, and set the hook function in an initial processing program, to generate the target processing program.

In an embodiment of the present disclosure, when sending the Berkeley Packet Filter program to the extended Berkeley Packet Filter module in the kernel space, the processing unit 31 is specifically configured to: compile the Berkeley Packet Filter program to generate a bytecode corresponding to the Berkeley Packet Filter program; and send the bytecode to the extended Berkeley Packet Filter module in the kernel space.

In an embodiment of the present disclosure, when generating the kernel native code after the extended Berkeley Packet Filter module processes the Berkeley Packet Filter program, the processing unit 31 is specifically configured to: load, through the extended Berkeley Packet Filter module, the bytecode corresponding to the Berkeley Packet Filter program; and verify, through the extended Berkeley Packet Filter module, the bytecode to obtain a verification result, and convert the bytecode into the kernel native code if the verification result indicates that the verification succeeds.

In an embodiment of the present disclosure, the processing unit 31 is further configured to: if the verification result indicates that the verification fails, return verification information to the user-mode application, where the verification information represents the verification result and/or a cause of the verification result.

In an embodiment of the present disclosure, the extended Berkeley Packet Filter module includes a verifier sub-module and a just-in-time compilation sub-module; when verifying, through the extended Berkeley Packet Filter module, the bytecode, to obtain the verification result, the processing unit 31 is specifically configured to: verify, through the verifier sub-module, operation security of the bytecode to obtain the verification result; and when converting the bytecode into the kernel native code, the processing unit 31 is specifically configured to: convert, through the just-in-time compilation sub-module, the bytecode into the kernel native code in the kernel space.

The processing unit 31 is connected to the control unit 32. The request processing apparatus 3 provided in this embodiment can execute the technical solution of the above method embodiment. The implementation principles and the technical effects are similar, which will not be described here in this embodiment.

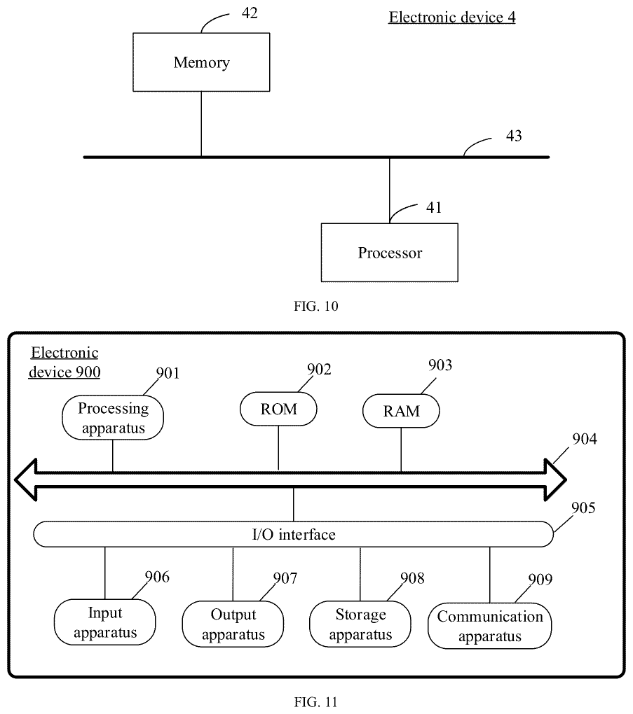

FIG. 10 is a schematic structural diagram of an electronic device according to an embodiment of the present disclosure. As shown in FIG. 10, the electronic device 4 includes:
a processor 41 and a memory 42 connected to the processor 41 in a communication way;
the memory 42 stores a computer-executable instruction; and
the processor 41 executes the computer-executable instruction stored in the memory 42, to implement the request processing method in the embodiment shown in FIG. 2 to FIG. 8.

In an implementation, the processor 41 is connected to the memory 42 by using a bus 43.

For related descriptions, reference may be made to corresponding related descriptions and effects of the steps in the embodiments corresponding to FIG. 2 to FIG. 8 for understanding, and details are not described herein again.

An embodiment of the present disclosure provides a computer-readable storage medium. The computer-readable storage medium stores a computer-executable instruction which, when executed by a processor, implement the request processing method provided in any one of the embodiments corresponding to FIG. 2 to FIG. 8 of the present disclosure.

An embodiment of the present disclosure provides a computer program product, including a computer program, where the computer program, when executed by a processor, implements the request processing method provided in any one of the embodiments corresponding to FIG. 2 to FIG. 8 of the present disclosure.

To implement the foregoing embodiments, an embodiment of the present disclosure further provides an electronic device.

With reference to FIG. 11, FIG. 11 shows a schematic structural diagram of an electronic device 900 suitable for implementing an embodiment of the present disclosure. The electronic device 900 may be a terminal device or a server. The terminal device may include, but is not limited to, mobile terminals such as a mobile phone, a notebook computer, a digital broadcast receiver, a personal digital assistant (PDA), a portable android device (PAD), a portable media player (PMP), and a vehicle-mounted terminal (such as a vehicle navigation terminal), and fixed terminals such as a digital TV and a desktop computer. The electronic device shown in FIG. 11 is merely an example, and shall not impose any limitation on the functions and scope of use of the embodiments of the present disclosure.

As shown in FIG. 11, the electronic device 900 may include a processing apparatus (for example, a central processing unit, a graphics processing unit, etc.) 901 that may perform a variety of appropriate actions and processing in accordance with a program stored in a read-only memory (ROM) 902 or a program loaded from a storage apparatus 908 into a random access memory (RAM) 903. The RAM 903 further stores various programs and data required for the operation of the electronic device 900. The processing apparatus 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906 including, for example, a touchscreen, a touchpad, a keyboard, a mouse, a camera, a microphone, an accelerometer, a gyroscope, etc.; an output apparatus 907 including, for example, a liquid crystal display (LCD), a speaker, a vibrator, etc.; a storage apparatus 908 including, for example, a tape, a hard disk, etc.; and a communication apparatus 909. The communication apparatus 909 may allow the electronic device 900 to perform wireless or wired communication with other devices to exchange data. Although FIG. 11 shows the electronic device 900 having various apparatuses, it should be understood that it is not required to implement or have all of the shown apparatuses. It may be an alternative to implement or have more or fewer apparatuses.

In particular, according to an embodiment of the present disclosure, the processes described above with reference to the flowcharts may be implemented as a computer software program. For example, this embodiment of the present disclosure includes a computer program product, which includes a computer program carried on a computer-readable medium, where the computer program includes a program code for performing the method shown in the flowchart. In such an embodiment, the computer program may be downloaded from a network through the communication apparatus 909 and installed, installed from the storage apparatus 908, or installed from the ROM 902. When the computer program is executed by the processing apparatus 901, the above-mentioned functions defined in the method of the embodiment of the present disclosure are performed.

It should be noted that the computer-readable medium described above in the present disclosure may be a computer-readable signal medium, a computer-readable storage medium, or a combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program, which may be used by or in combination with an instruction execution system, an apparatus, or a device. In the present disclosure, the computer-readable signal medium may include a data signal propagated in a baseband or as a part of a carrier, where the data signal carries a computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with the instruction execution system, the apparatus, or the device. The program code contained in the computer-readable medium may be transmitted by any suitable medium, including but not limited to: electric wires, optical cables, radio frequency (RF), etc., or any suitable combination thereof.

The above computer-readable medium may be contained in the foregoing electronic device. Alternatively, the computer-readable medium may exist independently, without being assembled into the electronic device.

The above computer-readable medium carries one or more programs that, when executed by the electronic device, cause the electronic device to perform the method shown in the above embodiment.

The computer program code for performing the operations in the present disclosure can be written in one or more programming languages or a combination thereof, where the programming languages include object-oriented programming languages, such as Java, Smalltalk, and C++, and further include conventional procedural programming languages, such as “C” language or similar programming languages. The program code may be completely executed in a computer of a user, partially executed in a computer of a user, executed as an independent software package, partially executed in a computer of a user and partially executed in a remote computer, or completely executed in a remote computer or server. In the circumstance involving the remote computer, the remote computer may be connected to a computer of a user over any type of network, including a local area network (LAN) or a wide area network (WAN), or may be connected to an external computer (for example, connected over the Internet using an Internet service provider).

The flowcharts and the block diagrams in the accompanying drawings illustrate the possibly implemented architecture, functions, and operations of the system, the method, and the computer program product according to various embodiments of the present disclosure. In this regard, each block in the flowchart or the block diagram may represent a module, a program segment, or part of codes, and the module, the program segment, or part of the codes contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in a reverse order, depending on the functions involved. It should also be noted that each block in the block diagram and/or the flowchart, and a combination of the blocks in the block diagram and/or the flowchart can be implemented by a dedicated hardware-based system that executes specified functions or operations, or can be implemented by a combination of dedicated hardware and computer instructions.

The related units described in the embodiments of the present disclosure may be implemented by software, or may be implemented by hardware. A name of a unit does not constitute a limitation on the unit itself in some cases, for example, a first obtaining unit may also be described as “a unit for obtaining at least two Internet protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium that may contain or store a program used by or in combination with the instruction execution system, the apparatus, or the device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to a first aspect, one or more embodiments of the present disclosure provide a request processing method, including:
after receiving an input/output request sent by a virtual machine client located in user space, calling a kernel virtual machine module in kernel space to determine a target processing program corresponding to the input/output request, where the target processing program includes a hook function for implementing an instruction processing flow corresponding to the input/output request, and the hook function is mapped to a kernel native code executable by a kernel; and performing an operation on a virtual input/output device at a virtual machine host by executing the target processing program in the kernel space, to obtain a request result.

According to one or more embodiments of the present disclosure, the operating on the virtual input/output device at the virtual machine host by executing the target processing program in the kernel space, to obtain the request result includes: calling, through the kernel virtual machine module, the hook function in the target processing program, to obtain a target kernel native code corresponding to the hook function; and executing, through a processor process corresponding to the kernel virtual machine module, the target kernel native code, to perform the operation on the virtual input/output device at the virtual machine host, to obtain the request result.

According to one or more embodiments of the present disclosure, the executing, through the processor process corresponding to the kernel virtual machine module, the target kernel native code, to perform an operation on the virtual input/output device at the virtual machine host, to obtain the request result includes: reading a virtual input/output queue to obtain a virtual memory region of operation data corresponding to the input/output request; returning a processor process of the virtual machine client to the kernel space; and executing, through the processor process, the target kernel native code, to write the operation data corresponding to the virtual memory region into the virtual input/output device, or write data in the virtual input/output device into the virtual memory region.

According to one or more embodiments of the present disclosure, before receiving the input/output request sent by the virtual machine client located in the user space, the method further includes: loading, through a user-mode application, a Berkeley Packet Filter program, where the Berkeley Packet Filter program is used for representing a setting position of the hook function and an instruction processing flow corresponding to the hook function; sending the Berkeley Packet Filter program to an extended Berkeley Packet Filter module in the kernel space, and generating the kernel native code after the extended Berkeley Packet Filter module processes the Berkeley Packet Filter program; and mapping the kernel native code to the corresponding hook function, and setting the hook function in an initial processing program, to generate the target processing program.

According to one or more embodiments of the present disclosure, the sending the Berkeley Packet Filter program to the extended Berkeley Packet Filter module in the kernel space includes: compiling the Berkeley Packet Filter program to generate a bytecode corresponding to the Berkeley Packet Filter program; and sending the bytecode to the extended Berkeley Packet Filter module in the kernel space.

According to one or more embodiments of the present disclosure, the generating the kernel native code after the extended Berkeley Packet Filter module processes the Berkeley Packet Filter program includes: loading, through the extended Berkeley Packet Filter module, the bytecode corresponding to the Berkeley Packet Filter program; and verifying, through the extended Berkeley Packet Filter module, the bytecode to obtain a verification result, and converting the bytecode into the kernel native code if the verification result indicates that the verification succeeds.

According to one or more embodiments of the present disclosure, the method further includes: if the verification result indicates that the verification fails, returning verification information to the user-mode application, where the verification information represents the verification result and/or a cause of the verification result.

According to one or more embodiments of the present disclosure, the extended Berkeley Packet Filter module includes a verifier sub-module and a just-in-time compilation sub-module; the verifying, through the extended Berkeley Packet Filter module, the bytecode to obtain the verification result includes: verifying, through the verifier sub-module, operation security of the bytecode to obtain the verification result; and the converting the bytecode into the kernel native code includes: converting, through the just-in-time compilation sub-module, the bytecode into the kernel native code in the kernel space.

According to a second aspect, one or more embodiments of the present disclosure provide a request processing apparatus, including:
a processing unit, configured to: after receiving an input/output request sent by a virtual machine client located in user space, call a kernel virtual machine module in kernel space to determine a target processing program corresponding to the input/output request, where the target processing program includes a hook function for implementing an instruction processing flow corresponding to the input/output request, and the hook function is mapped to a kernel native code executable by a kernel; and
a control unit, configured to perform an operation on a virtual input/output device at a virtual machine host by executing the target processing program in the kernel space, to obtain a request result.

According to one or more embodiments of the present disclosure, when performing the operation on the virtual input/output device at the virtual machine host by executing the target processing program in the kernel space, to obtain the request result, the control unit is specifically configured to: call, through the kernel virtual machine module, the hook function in the target processing program, to obtain a target kernel native code corresponding to the hook function; and execute, through a processor process corresponding to the kernel virtual machine module, the target kernel native code, to perform an operation on the virtual input/output device at the virtual machine host, to obtain the request result.

According to one or more embodiments of the present disclosure, when executing, through the processor process corresponding to the kernel virtual machine module, the target kernel native code, to perform an operation on the virtual input/output device at the virtual machine host, to obtain the request result, the control unit is specifically configured to: read a virtual input/output queue to obtain a virtual memory region of operation data corresponding to the input/output request; return a processor process of the virtual machine client to the kernel space; and execute, through the processor process, the target kernel native code, to write the operation data corresponding to the virtual memory region into the virtual input/output device, or write data in the virtual input/output device into the virtual memory region.

According to one or more embodiments of the present disclosure, before the receiving the input/output request sent by the virtual machine client in the user space, the processing unit is further configured to: load, through a user-mode application, a Berkeley Packet Filter program, where the Berkeley Packet Filter program is used for representing a setting position of the hook function and an instruction processing flow corresponding to the hook function; send the Berkeley Packet Filter program to an extended Berkeley Packet Filter module in the kernel space, and generate the kernel native code after the extended Berkeley Packet Filter module processes the Berkeley Packet Filter program; and map the kernel native code to the corresponding hook function, and set the hook function in an initial processing program, to generate the target processing program.

According to one or more embodiments of the present disclosure, when sending the Berkeley Packet Filter program to the extended Berkeley Packet Filter module in the kernel space, the processing unit is specifically configured to: compile the Berkeley Packet Filter program to generate a bytecode corresponding to the Berkeley Packet Filter program; and send the bytecode to the extended Berkeley Packet Filter module in the kernel space.

According to one or more embodiments of the present disclosure, when generating the kernel native code after the extended Berkeley Packet Filter module processes the Berkeley Packet Filter program, the processing unit is specifically configured to: load, through the extended Berkeley Packet Filter module, the bytecode corresponding to the Berkeley Packet Filter program; and verify, through the extended Berkeley Packet Filter module, the bytecode to obtain a verification result, and convert the bytecode into the kernel native code if the verification result indicates that the verification succeeds.

According to one or more embodiments of the present disclosure, the processing unit is further configured to: if the verification result indicates that the verification fails, return verification information to the user-mode application, where the verification information represents the verification result and/or a cause of the verification result.

According to one or more embodiments of the present disclosure, the extended Berkeley Packet Filter module includes a verifier sub-module and a just-in-time compilation sub-module; when verifying, through the extended Berkeley Packet Filter module, the bytecode, to obtain the verification result, the processing unit is specifically configured to: verify, through the verifier sub-module, operation security of the bytecode to obtain the verification result; and when converting the bytecode into the kernel native code, the processing unit is specifically configured to: convert, through the just-in-time compilation sub-module, the bytecode into the kernel native code in the kernel space.

According to a third aspect, one or more embodiments of the present disclosure provide an electronic device, including: at least one processor and a memory;
the memory stores a computer-executable instruction; and
the at least one processor executes the computer-executable instruction stored in the memory, such that the at least one processor executes the request processing method according to the first aspect and the various possible designs of the first aspect.

According to a fourth aspect, one or more embodiments of the present disclosure provide a computer-readable storage medium, where a computer-executable instruction is stored in the computer-readable storage medium, and when a processor executes the computer-executable instruction, the request processing method according to the first aspect and the various possible designs of the first aspect is implemented.

According to a fifth aspect, one or more embodiments of the present disclosure provide a computer program product, including a computer program, where the computer program, when executed by a processor, implements the request processing method according to the first aspect and the various possible designs of the first aspect.

The foregoing descriptions are merely preferred embodiments of the present disclosure and explanations of the applied technical principles. A person skilled in the art should understand that the scope of disclosure involved in the present disclosure is not limited to the technical solution formed by a specific combination of the foregoing technical features, and shall also cover other technical solutions formed by any combination of the foregoing technical features or equivalent features thereof without departing from the foregoing concept of disclosure, for example, a technical solution formed by replacing the foregoing features with technical features having similar functions disclosed in the present disclosure (but not limited thereto).

In addition, although the various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment can also be implemented in multiple embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms for implementing the claims.

What is claimed is:

1. A request processing method, comprising:
after receiving an input/output request sent by a virtual machine client located in user space, calling a kernel virtual machine module in kernel space to determine a target processing program corresponding to the input/output request, wherein the target processing program comprises a hook function for implementing an instruction processing flow corresponding to the input/output request, and the hook function is mapped to a kernel native code executable by a kernel;
performing an operation on a virtual input/output device at a virtual machine host by executing the target processing program in the kernel space, to obtain a request result.

2. The method according to claim 1, wherein the performing the operation on the virtual input/output device at the virtual machine host by executing the target processing program in the kernel space, to obtain the request result comprises:
calling, through the kernel virtual machine module, the hook function in the target processing program, to obtain a target kernel native code corresponding to the hook function;
executing, through a processor process corresponding to the kernel virtual machine module, the target kernel native code, to perform the operation on the virtual input/output device at the virtual machine host, to obtain the request result.

3. The method according to claim 2, wherein the executing, through the processor process corresponding to the kernel virtual machine module, the target kernel native code, to perform the operation on the virtual input/output device at the virtual machine host, to obtain the request result comprises:
reading a virtual input/output queue to obtain a virtual memory region of operation data corresponding to the input/output request;
returning a processor process of the virtual machine client to the kernel space;
executing, through the processor process, the target kernel native code, to write the operation data corresponding to the virtual memory region into the virtual input/output device, or write data in the virtual input/output device into the virtual memory region.

4. The method according to claim 1, wherein before receiving the input/output request sent by the virtual machine client located in the user space, the method further comprises:
loading, through a user-mode application, a Berkeley Packet Filter program, wherein the Berkeley Packet Filter program is used for representing a setting position of the hook function and an instruction processing flow corresponding to the hook function;
sending the Berkeley Packet Filter program to an extended Berkeley Packet Filter module in the kernel space, and generating the kernel native code after the extended Berkeley Packet Filter module processes the Berkeley Packet Filter program;
mapping the kernel native code to the hook function, and setting the hook function in an initial processing program, to generate the target processing program.

5. The method according to claim 4, wherein the sending the Berkeley Packet Filter program to the extended Berkeley Packet Filter module in the kernel space comprises:
compiling the Berkeley Packet Filter program to generate a bytecode corresponding to the Berkeley Packet Filter program;
sending the bytecode to the extended Berkeley Packet Filter module in the kernel space.

6. The method according to claim 4, wherein the generating the kernel native code after the extended Berkeley Packet Filter module processes the Berkeley Packet Filter program comprises:
loading, through the extended Berkeley Packet Filter module, the bytecode corresponding to the Berkeley Packet Filter program;
verifying, through the extended Berkeley Packet Filter module, the bytecode to obtain a verification result, and converting the bytecode into the kernel native code if the verification result indicates that the verification succeeds.

7. The method according to claim 6, wherein the method further comprises:
if the verification result indicates that the verification fails, returning verification information to the user-mode application, wherein the verification information represents the verification result and/or a cause of the verification result.

8. The method according to claim 6, wherein the extended Berkeley Packet Filter module comprises a verifier sub-module and a just-in-time compilation sub-module;
the verifying, through the extended Berkeley Packet Filter module, the bytecode to obtain the verification result comprises:
verifying, through the verifier sub-module, operation security of the bytecode to obtain the verification result;
the converting the bytecode into the kernel native code comprises:
converting, through the just-in-time compilation sub-module, the bytecode into the kernel native code in the kernel space.

9. A request processing apparatus, comprising: a processor and a memory;
wherein the memory stores a computer-executable instruction;
the computer-executable instruction which, when executed by the processor, causes the processor to:
after receiving an input/output request sent by a virtual machine client located in user space, call a kernel virtual machine in kernel space to determine a target processing program corresponding to the input/output request, wherein the target processing program comprises a hook function for implementing an instruction processing flow corresponding to the input/output request, and the hook function is mapped to a kernel native code executable by a kernel;
perform an operation on a virtual input/output device at a virtual machine host by executing the target processing program in the kernel space, to obtain a request result.

10. The apparatus according to claim 9, wherein when performing the operation on the virtual input/output device at the virtual machine host by executing the target processing program in the kernel space, to obtain the request result, the processor is specifically caused to:
call, through the kernel virtual machine, the hook function in the target processing program, to obtain a target kernel native code corresponding to the hook function;
execute, through a processor process corresponding to the kernel virtual machine, the target kernel native code, to perform the operation on the virtual input/output device at the virtual machine host, to obtain the request result.

11. The apparatus according to claim 10, wherein when executing, through the processor process corresponding to the kernel virtual machine, the target kernel native code, to perform the operation on the virtual input/output device at the virtual machine host, to obtain the request result, the processor is specifically caused to:
read a virtual input/output queue to obtain a virtual memory region of operation data corresponding to the input/output request;
return a processor process of the virtual machine client to the kernel space;
execute, through the processor process, the target kernel native code, to write the operation data corresponding to the virtual memory region into the virtual input/output device, or write data in the virtual input/output device into the virtual memory region.

12. The apparatus according to claim 9, wherein before receiving the input/output request sent by the virtual machine client located in the user space, the processor is further caused to:
load, through a user-mode application, a Berkeley Packet Filter program, wherein the Berkeley Packet Filter program is used for representing a setting position of the hook function and an instruction processing flow corresponding to the hook function;
send the Berkeley Packet Filter program to an extended Berkeley Packet Filter in the kernel space, and generate the kernel native code after the extended Berkeley Packet Filter processes the Berkeley Packet Filter program;
map the kernel native code to the hook function, and set the hook function in an initial processing program, to generate the target processing program.

13. The apparatus according to claim 12, wherein when sending the Berkeley Packet Filter program to the extended Berkeley Packet Filter in the kernel space, the processor is specifically caused to:
compile the Berkeley Packet Filter program to generate a bytecode corresponding to the Berkeley Packet Filter program;
send the bytecode to the extended Berkeley Packet Filter in the kernel space.

14. The apparatus according to claim 12, wherein when generating the kernel native code after the extended Berkeley Packet Filter processes the Berkeley Packet Filter program, the processor is specifically caused to:
load, through the extended Berkeley Packet Filter, the bytecode corresponding to the Berkeley Packet Filter program;
verify, through the extended Berkeley Packet Filter, the bytecode to obtain a verification result, and convert the bytecode into the kernel native code if the verification result indicates that the verification succeeds.

15. The apparatus according to claim 14, wherein the processor is further caused to:
if the verification result indicates that the verification fails, return verification information to the user-mode application, wherein the verification information represents the verification result and/or a cause of the verification result.

16. The apparatus according to claim 14, wherein when verifying, through the extended Berkeley Packet Filter, the bytecode to obtain the verification result, the processor is specifically caused to:
verify operation security of the bytecode to obtain the verification result;
when converting the bytecode into the kernel native code, the processor is specifically caused to:
convert the bytecode into the kernel native code in the kernel space.

17. An electronic device, comprising: a processor and a memory;
wherein the memory stores a computer-executable instruction;
the processor executes the computer-executable instruction stored in the memory, such that the processor executes the request processing method according to claim 1.

18. A non-transitory computer-readable storage medium, wherein the computer-readable storage medium stores a computer-executable instruction which, when executed by the processor, causes the processor to perform the following:
after receiving an input/output request sent by a virtual machine client located in user space, calling a kernel virtual machine in kernel space to determine a target processing program corresponding to the input/output request, wherein the target processing program comprises a hook function for implementing an instruction processing flow corresponding to the input/output request, and the hook function is mapped to a kernel native code executable by a kernel;
performing an operation on a virtual input/output device at a virtual machine host by executing the target processing program in the kernel space, to obtain a request result.

19. The storage medium according to claim 18, wherein when performing the operation on the virtual input/output device at the virtual machine host by executing the target processing program in the kernel space, to obtain the request result, the processor is further caused to perform the following:
calling, through the kernel virtual machine, the hook function in the target processing program, to obtain a target kernel native code corresponding to the hook function;
executing, through a processor process corresponding to the kernel virtual machine, the target kernel native code, to perform the operation on the virtual input/output device at the virtual machine host, to obtain the request result.

20. A non-transitory computer-readable storage medium, wherein the computer-readable storage medium stores a computer-executable instruction which, when executed by the processor, causes the processor to perform the method according to claim 1.
